(19) United States
(12) Patent Application Publication
(10) Pub. No.: US 2024/0015763 A1
(43) Pub. Date: Jan. 11, 2024

(54) SCHEDULING IN A RADIO TELECOMMUNICATIONS NETWORK

(71) Applicant: NOKIA TECHNOLOGIES OY, Espoo (FI)

(72) Inventor: Xiaomao MAO, Massy (FR)

(21) Appl. No.: 18/255,206

(22) PCT Filed: Nov. 26, 2021
(86) PCT No.: PCT/EP2021/083137

§ 371 Date: May 31, 2023

(30) Foreign Application Priority Data
Dec. 1, 2020 (FI) 20206234

(51) Int. Cl. H04W 72/232; H04W 72/12

(52) U.S. Cl. CPC H04W 72/232; H04W 72/12

(57) ABSTRACT

A network node comprising means for: sending to a user equipment (UE) a downlink control information (DCI) format for encoding variable scheduling information as a scheduling sequence, wherein the scheduling information is for scheduling the UE for data communication, and wherein the DCI format uses different fields and at least one of the fields is an adjustable bit width field having a first bit width; using a scheduling sequence to communicate scheduling information to the UE, using the DCI format, by assigning values to the fields of the DCI format including the at least one field of the first bit width; in dependence upon use or usability of scheduling sequences within an adjustable range of possible scheduling sequences enabled by a variation in a bit width of the at least one adjustable bit width field of the DCI format, sending to the UE an adjusted DCI format for encoding variable scheduling information as a scheduling sequence, wherein the scheduling information is for scheduling the UE for data communication, and wherein the adjusted DCI format uses different fields and the at least one adjustable bit width field has a second bit width that is different to the first bit width; and using a scheduling sequence to communicate scheduling information to the UE, using the adjusted DCI format, by assigning values to the fields of the adjusted DCI format including the at least one adjustable bit width field of the second bit width.

### TECHNOLOGICAL FIELD

Embodiments of the present disclosure relate to scheduling in a radio telecommunications network.

### BACKGROUND

In a radio telecommunications network transmission can be scheduled. It can therefore be necessary to transfer scheduling information to a transmitter and/or a receiver.

### BRIEF SUMMARY

According to various, but not necessarily all, embodiments there is provided a network node comprising means for:
sending to a user equipment (UE) a downlink control information (DCI) format for encoding variable scheduling information as a scheduling sequence, wherein the scheduling information is for scheduling the UE for data communication, and wherein the DCI format uses different fields and at least one of the fields is an adjustable bit width field having a first bit width;
using a scheduling sequence to communicate scheduling information to the UE, using the DCI format, by assigning values to the fields of the DCI format including the at least one field of the first bit width;
in dependence upon use or usability of scheduling sequences within an adjustable range of possible scheduling sequences enabled by a variation in a bit width of the at least one adjustable bit width field of the DCI format, sending to the UE an adjusted DCI format for encoding variable scheduling information as a scheduling sequence, wherein the scheduling information is for scheduling the UE for data communication, and wherein the adjusted DCI format uses different fields and the at least one
adjustable bit width field has a second bit width that is different to the first bit width; and
using a scheduling sequence to communicate scheduling information to the UE,
using the adjusted DCI format, by assigning values to the fields of the adjusted DCI format including the at least one adjustable bit width field of the second bit width.

In some but not necessarily all examples adjustment of the DCI format is based on use or usability of scheduling sequences within an adjustable range of possible scheduling sequences enabled by a variation in a bit width of the at least one adjustable bit width field of the DCI format, wherein the DCI format uses different fields and wherein the at least one adjustable bit width field has a selected one of a plurality of possible bit widths.

In some but not necessarily all examples the second bit width is less than the first bit width.

In some but not necessarily all examples an adjustment of the first bit width of the at least one adjustable bit width field to the second bit width of the at least one adjustable bit width field decreases under-used scheduling sequences.

In some but not necessarily all examples an adjustment for the first bit width of the at least one adjustable bit width field to the second bit width of the at least one adjustable bit width field increases a range of used or usable scheduling sequences.

In some but not necessarily all examples an adjustment of the adjustable bit width field to the second bit width is based on a statistical model of use or usability of scheduling sequences wherein the adjustment of the adjustable bit width field to the second bit width from the first bit width comparatively optimizes a function defined by the statistical model.

In some but not necessarily all examples the statistical model is a model determined by unsupervised learning.

In some but not necessarily all examples the statistical model is a model that clusters scheduling sequences based on use or measured usability.

In some but not necessarily all examples the statistical model is a model that clusters scheduling sequences, in multiple dimensions, based on use or measured usability.

In some but not necessarily all examples, the network node comprises means for receiving from the UE a report indicative of measured usability of scheduling sequences within an adjustable range of possible scheduling sequences defined by the DCI format.

In some but not necessarily all examples a scheduling sequence is communicated, to the UE, implicitly or explicitly, using physical layer signalling and wherein the adjusted DCI format is sent to the UE via higher layer signalling.

According to various, but not necessarily all, embodiments there is provided a method comprising:
sending to a user equipment (UE) a downlink control information (DCI) format for encoding variable scheduling information as a scheduling sequence, wherein the scheduling information is for scheduling the UE for data communication, and wherein the DCI format uses different fields and at least one of the fields is an adjustable bit width field having a first bit width;
using a scheduling sequence to communicate scheduling information to the UE, using the DCI format, by assigning values to the fields of the DCI format including the at least one field of the first bit width;
   in dependence upon use or usability of scheduling sequences within an adjustable range of possible scheduling sequences enabled by a variation in a bit width of the at least one adjustable bit width field of the DCI format, sending to the UE an adjusted DCI format for encoding variable scheduling information as a scheduling sequence, wherein the scheduling information is for scheduling the UE for data communication, and wherein the adjusted DCI format uses different fields and the at least one adjustable bit width field has a second bit width that is different to the first bit width; and
   using a scheduling sequence to communicate scheduling information to the UE, using the adjusted DCI format, by assigning values to the fields of the adjusted DCI format including the at least one adjustable bit width field of the second bit width.

According to various, but not necessarily all, embodiments there is provided a computer program that when loaded by at least one processor enables:
changing in dependence upon use or usability of scheduling sequences within an adjustable range of possible scheduling sequences enabled by a variation in a bit width of the at least one adjustable bit width field of the DCI format, a downlink control information (DCI) format for encoding variable scheduling information as a scheduling sequence, wherein the scheduling information is for scheduling the UE for data communication, and wherein the DCI format uses different fields and at least one of the fields is an adjustable bit width field having a first bit width.

According to various, but not necessarily all, embodiments there is provided a system comprising the network node and at least the user equipment, wherein the user equipment comprises means for:
in response to receiving the DCI format comprising the adjustable bit width field having the first bit width, allocating first memory resources of a size determined by the first bit width, and
in response to receiving the DCI format comprising the adjustable bit width field having the first bit width, releasing the first memory resources and allocating second memory resources of a size determined by the second bit width.

According to various, but not necessarily all, embodiments there is provided a system comprising the network node and at least the user equipment, wherein the suer equipment comprises means for:
in response to receiving the DCI format comprising the adjustable bit width field having the first bit width, measuring usability of scheduling sequences in a range of DCI scheduling sequences dependent upon the first bit width and reporting to the network node an indication of measured usability of scheduling sequences in the range of DCI scheduling sequences dependent upon the first bit width; and
in response to receiving the DCI format comprising the adjustable bit width field having the second bit width, measuring usability of scheduling sequences in a range of DCI scheduling sequences dependent upon the second bit width and reporting to the network node an indication of measured usability of scheduling sequences in the range of DCI scheduling sequences dependent upon the second bit width.

According to various, but not necessarily all, embodiments there is provided a network node comprising means for:
sending to a user equipment (UE) an adjustable downlink control information (DCI) format for encoding variable scheduling information as a scheduling sequence, wherein the scheduling information is for scheduling the UE for data communication, and wherein the DCI format uses different fields and at least one of the fields has a selected one of a plurality of possible bit widths; and using a scheduling sequence to communicate scheduling information to a UE, using the adjustable DCI format, by assigning values to the fields of the DCI format including the at least one field of selected bit width, wherein selection of the bit width is dependent upon use or usability of scheduling sequences.

The selection of the bit width can be dependent upon use or measured usability of scheduling sequences of an adjustable range of possible scheduling sequences enabled by the DCI format.

The selection of the bit width can be dependent upon a statistical model of use or usability of scheduling sequences wherein the adapted DCI format optimizes a function defined by the statistical model.

According to various, but not necessarily all, embodiments there is provided examples as claimed in the appended claims.

### BRIEF DESCRIPTION

Some examples will now be described with reference to the accompanying drawings in which:

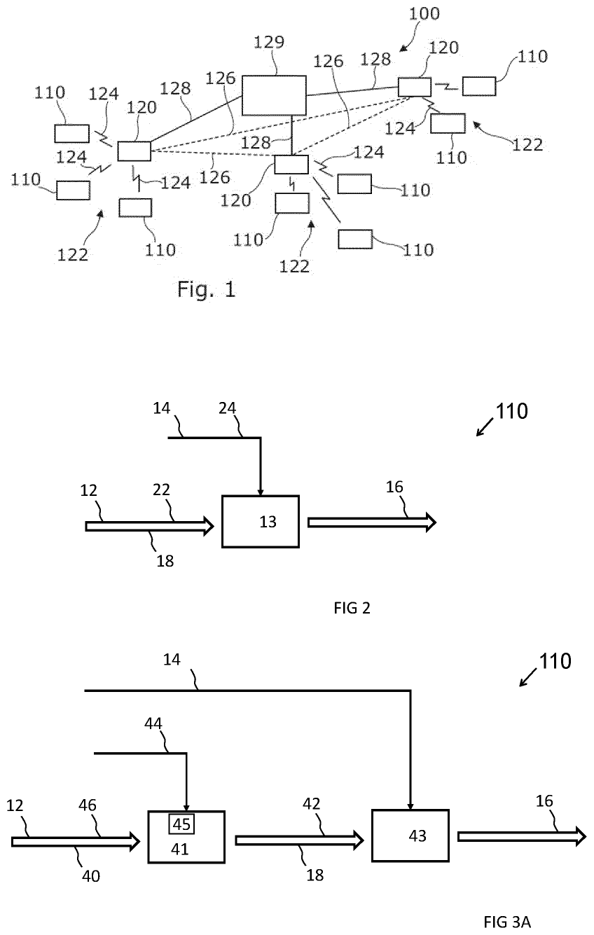

FIG. 1 shows an example of the subject matter described herein;

FIG. 2 shows another example of the subject matter described herein;

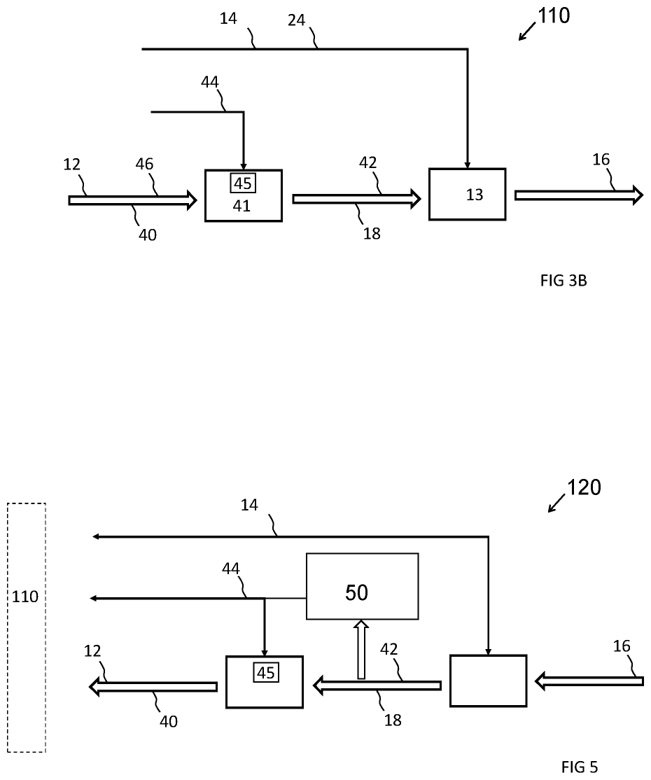

FIG. 3A shows another example of the subject matter described herein;

FIG. 3B shows another example of the subject matter described herein;

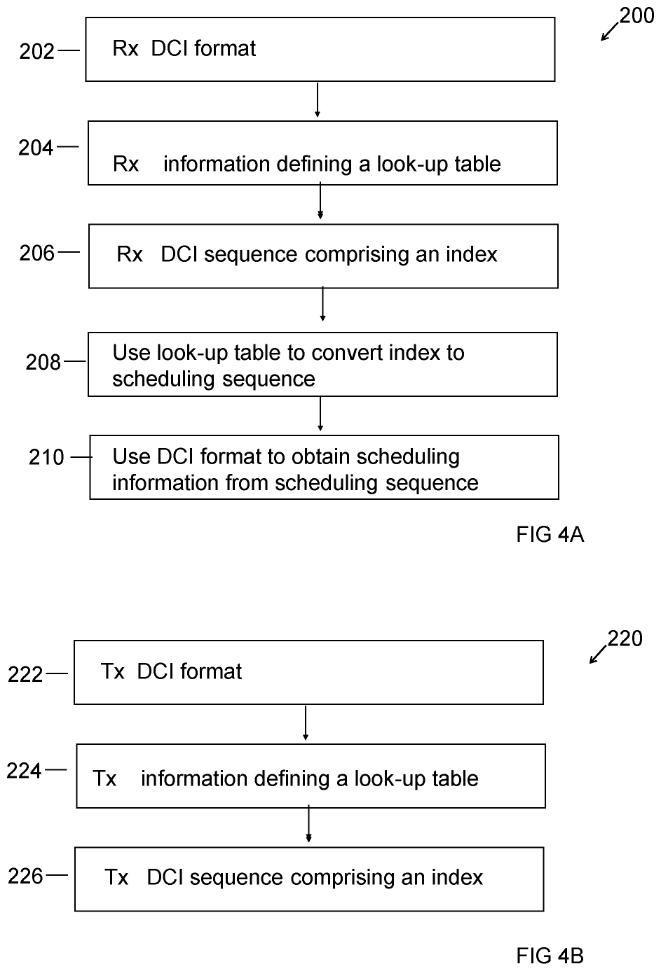

FIG. 4A shows another example of the subject matter described herein;

FIG. 4B shows another example of the subject matter described herein;

FIG. 5 shows another example of the subject matter described herein;

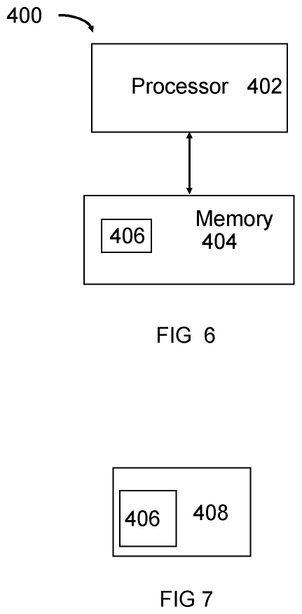

FIG. 6 shows another example of the subject matter described herein;

FIG. 7 shows another example of the subject matter described herein.

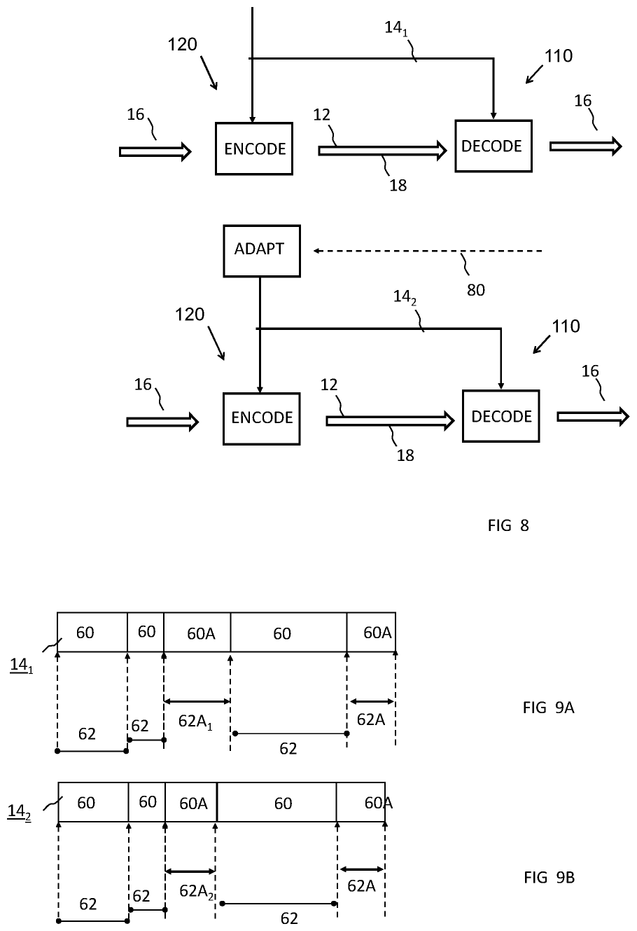

FIG. 8 shows another example of the subject matter described herein.

FIGS. 9A and 9B show another example of the subject matter described herein.

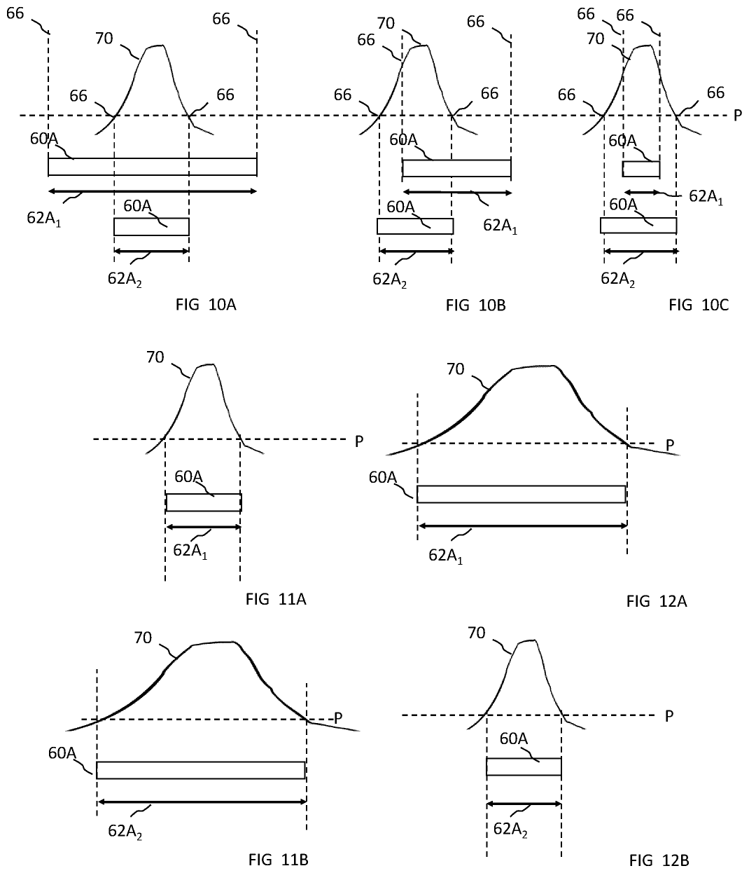

FIG. 10, 10B, 10C show examples of the subject matter described herein.

FIGS. 11A and 11B show another example of the subject matter described herein.

FIGS. 12A and 12B show another example of the subject matter described herein.

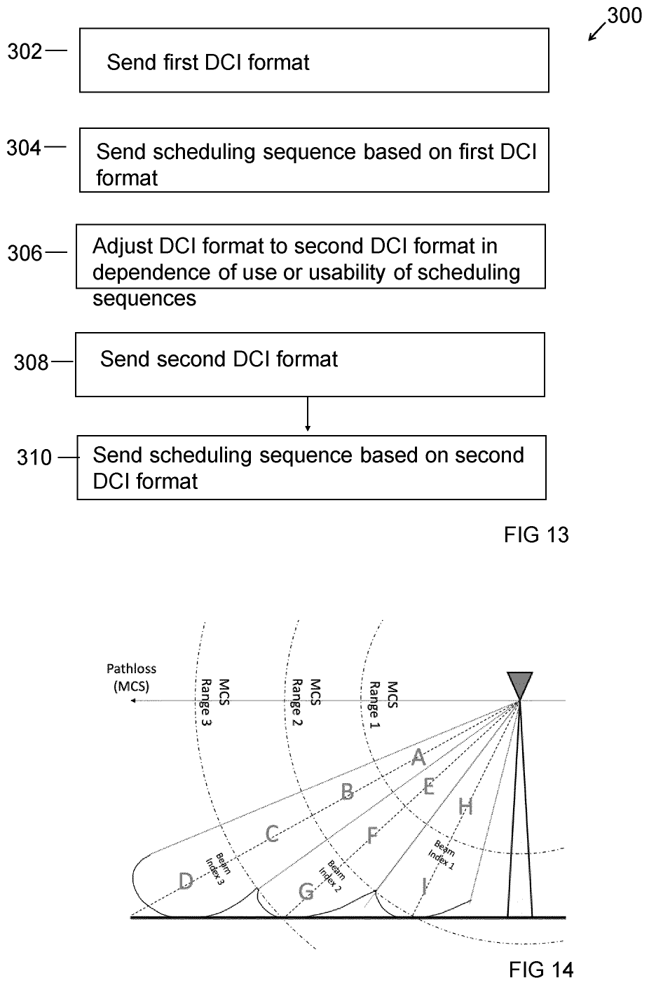

FIG. 13 shows another example of the subject matter described herein.

FIG. 14 shows another example of the subject matter described herein.

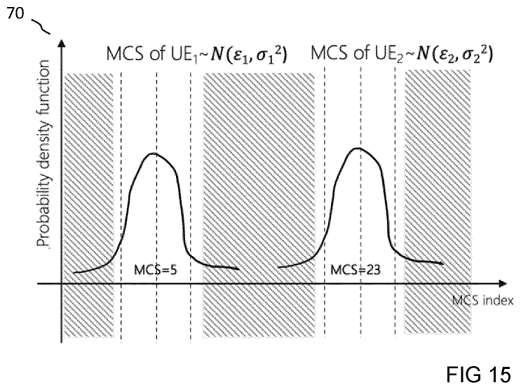

FIG. 15 shows another example of the subject matter described herein.

### DEFINITIONS

DCI: downlink control information.
Scheduling information: information for scheduling at least uplink transmissions from a user equipment.
DCI format: used to obtain scheduling information from a representation, based on the DCI format, of the scheduling information.
Scheduling sequence: a representation, based on a DCI format, of scheduling information.
DCI sequence: physical layer signalling that is converted to scheduling information.
Legacy DCI sequence: physical layer signalling comprising a representation, based on a legacy DCI format, of scheduling information. The representation is an explicit representation of a scheduling sequence.
Legacy DCI format: a DCI format used to obtain scheduling information from a legacy DCI sequence.
Nominate DCI sequence: physical layer signalling comprising a representation, based on a legacy DCI format, of scheduling information. The representation is an implicit representation of a scheduling sequence. It is an index for conversion to a scheduling sequence.
DL: Downlink
UL: Uplink
PDSCH: physical downlink shared channel
PUSCH: physical uplink shared channel
PDCCH: physical downlink control channel
ARQ: automatic repeat request
layer: a protocol layer of a protocol stack
RRC: Radio Resource Control
MAC: Medium Access Control

### DETAILED DESCRIPTION

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124. The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations. The user equipment (UE) comprises mobile equipment (ME).

In at least some examples, the ME/UE 110 satisfies the requirements of ultra-reliable low-latency communication (URLLC) as specified by 3GPP. In some examples, the UE 110 can operate with greater than 99.999% reliability and a latency of less than 1 ms. The UE 110 can, in some example, find application in the Internet of things (IoT) and/or the Industrial Internet of Things (IIOT). In some examples, the UE 110 can have a fixed location, for example, a fixed access device. In other examples, the UE 110 can be mobile. A UE 110 can, for example, be a personal (handheld) mobile telephone.

In the particular example illustrated the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an X2/Xn interface 126. The gNBs are also connected by means of the N2 interface 128 to the Access and Mobility management Function (AMF).

In a 3GPP network, downlink control information (DCI) is used to control scheduling. As illustrated in FIGS. 2, 3A, 3B a DCI sequence 12 is physical layer signalling that is converted to scheduling information 16. The scheduling information 16 is information for scheduling at least uplink transmissions from a user equipment 110. A DCI format 14 is used to obtain scheduling information 16 from a representation 18, based on the DCI format, of the scheduling information 16. The representation is a scheduling sequence.

A DCI sequence 12 is scheduling information signalling at the physical layer, via PDCCH. The DCI sequence 12 at least schedules DL transmissions on PDSCH and/or UL transmissions on PUSCH. A DCI sequence provides: downlink assignments containing at least modulation and coding format, resource allocation, and hybrid-ARQ information; and/or uplink scheduling grants containing at least modulation and coding format, resource allocation, and hybrid-ARQ information.

A representation 18, based on a DCI format 14, of scheduling Information 16, comprises information bits a₀ to a_{A-1}. The DCI format 14 defines fields and a mapping between fields of scheduling information 16 and the information bits a₀ to a_{A-1} of the representation 18, based on the DCI format 14. For example, each field can be mapped in the order in which it appears in a description of the DCI format in 3GPP TS 36.212, including the zero-padding bit(s), if any, with the first field mapped to the lowest order information bit a₀ and each successive field mapped to higher order information bits. The most significant bit of each field is mapped to the lowest order information bit for that field, e.g. the most significant bit of the first field is mapped to a₀.

In the example illustrated in FIG. 2, a representation 18 (a scheduling sequence), based on a DCI format 14, of the scheduling information 16 is comprised in a DCI sequence 12. This FIG. 2 corresponds to a legacy 3GPP implementation in which the DCI sequence 12 is a legacy DCI sequence 22. The legacy DCI sequence 22 is physical layer signalling comprising a representation 18, based on a legacy DCI format 24, of scheduling information 16. Legacy DCI format 24 is a DCI format 14 used to obtain scheduling information 16 from a legacy DCI sequence 22. The legacy DCI formats 24 include Formats 0, 0A, 0B . . . 7-1F, 7-1G as described in 3GPP TS 36.212 V16.2.0 (2020 June).

The mobile equipment 110 in FIG. 2 comprises means for:
receiving a DCI format 14;
receiving a DCI sequence 12 at the physical layer, the DCI sequence 12 comprising a representation 18, based on the DCI format 14, of scheduling information 16; and using the DCI format 14 to obtain 13 the scheduling information 16, for configuring the mobile equipment 110 for data communication, from the DCI sequence 12 representing 18, based on the DCI format 14, the scheduling information 16.

In the example illustrated in FIGS. 3A and 3B, a representation 18, based on a DCI format 14, of the scheduling information 16 is comprised in a scheduling sequence 42. The DCI sequence 12 is physical layer signalling comprising an index 40 that is converted to scheduling sequence 42 via a look-up table 45. The DCI sequence 12 comprising an index 40 can be referred to as a nominate DCI sequence 46. In FIG. 3B, the representation 18, comprised in a scheduling sequence 42, is a representation based on a legacy DCI format 24.

FIGS. 3A and 3B, illustrate examples of a mobile equipment 110 comprising means for:
receiving via signalling at a higher layer than a physical layer, a downlink control information format 14;
receiving via signalling at a higher layer than the physical layer, information 44 defining a look-up table 45 for converting a received index 40 to a scheduling sequence 42 representing, based on the DCI format 14, scheduling information 16; receiving a downlink control information sequence 12 at the physical layer, the DCI sequence 12 comprising an index 40 for indexing one of a plurality of predetermined different scheduling sequences 42;
using the look-up table 45 to convert 41 the received index 40 to a scheduling sequence 42 comprising a representation 18, based on the DCI format 14, of scheduling information 16; and
using the DCI format 14 to obtain 43 the scheduling information 16, for configuring the mobile equipment 110 for data communication, from the scheduling sequence 42 representing, based on the DCI format 14, the scheduling information 16.

In FIG. 3B the DCI format is a legacy DCI format 24. The look-up table 45 is configured to convert 41 a received index 40 to a scheduling sequence 42 comprising a representation 18, based on the legacy DCI format 24, of scheduling information 16. The process for obtaining 13 the scheduling information 16 from representation 18, based on the legacy DCI format 24, of the scheduling information 16 is the same as in FIG. 2. In FIG. 2 the representation 18 is comprised explicitly, using a scheduling sequence 42, within the legacy DCI sequence 22. In FIG. 3B, the representation 18 is comprised in a scheduling sequence 42 that is comprised implicitly within the DCI sequence 12 using an index 40

It will be appreciated that the process for obtaining the scheduling information 16 from the DCI sequence 12 (FIG. 2) is a one-hop (13) process whereas in FIG. 3A it is a two-hop (41, 43) process and in FIG. 3B it is a two-hop (41, 13) process.

It will be appreciated that DCI sequence 12 in FIGS. 3A and 3B comprises an index 40. The DCI sequence 12 is a nominate DCI sequence 46 different to a legacy DCI index 22 in that the nominate DCI sequence 46 comprises an index 40 that is ultimately used to obtain 41 a representation 18 (scheduling sequence 42), based on the DCI format 14, of scheduling information 16 and the legacy DCI sequence 22 comprises the representation 18 (scheduling sequence), based on the legacy DCI format 24, of the scheduling information 16.

FIG. 4A illustrates an example of a method 200. The method can be performed at a network node, for example a user equipment 110.

At block 202, the method 200 comprises receiving via signalling at a higher layer than a physical layer, a downlink control information (DCI) format 14.

At block 204, the method 200 comprises receiving via signalling at a higher layer than the physical layer, information 44 defining a look-up table 45 for converting a received index to a scheduling sequence representing, based on the DCI format, scheduling information.

At block 206, the method 200 comprises receiving a DCI sequence 12 at the physical layer, the DCI sequence comprising an index 40 for indexing one of a plurality of predetermined different scheduling sequences.

At block 208, the method 200 comprises using the look-up table 45 to convert the received index 40 to a scheduling sequence 42 comprising a representation 18, based on the DCI format 14, of scheduling information.

At block 210, the method 200 comprises using the DCI format 14 to obtain the scheduling information 16, for configuring the mobile equipment 110 for data communication, from the scheduling sequence 42 representing 18, based on the DCI format 14, the scheduling information 16.

While the processes of FIGS. 3A and 3B, and FIG. 4A have been described with reference to the user equipment 10, there are corresponding processes performed at a network node as illustrated in FIG. 4B and FIG. 5.

FIG. 4B illustrates an example of a method 220. The method can be performed at a network node, for example an access node 120.

At block 222, the method 220 comprises sending to a user equipment (UE) 110, via signalling at a higher layer than a physical layer, a DCI format 14, that enables the UE 110 to obtain scheduling information 16, for scheduling the UE 110 for data communication, from a scheduling sequence 42 comprising a representation 18, based on the DCI format 14, of the scheduling information 16.

At block 224, the method 220 comprises sending to a user equipment (UE) 110, via signalling at a higher layer than a physical layer, information 44 defining a look-up table 45 for converting an index 40 to a scheduling sequence 42 comprising a representation 18, based on the DCI format 14, of the scheduling information 16. At block 226, the method 220 comprises sending to a user equipment (UE) 110 a DCI sequence 12 at the physical layer, the DCI sequence 12 comprising an index 40 indexing one of a plurality of predetermined different scheduling sequences 42.

As illustrated in FIG. 5, the network node, for example access node 120 can comprise means for:
sending to a user equipment (UE) 110, via signalling at a higher layer than a physical layer:
   a DCI format 14, that enables the UE 110 to obtain scheduling information 16, for scheduling the UE 110 for data communication, from a scheduling sequence 42 representing 18, based on the DCI format 14, the scheduling information 16; and
   information 44 defining a look-up table 45 for converting an index 40 to a scheduling sequence 42 representing 18, based on the DCI format 14, the scheduling information 16; and
sending to the user equipment 110 a DCI sequence 12 at the physical layer, the DCI sequence 12 comprising an index 40 indexing one of a plurality of predetermined different scheduling sequences 42.

The processes of FIGS. 3A and 3B can be run in reverse by the network to convert scheduling information 16 to an index comprised in a DCI sequence 12.

For example, as illustrated in FIG. 5, the network 120 can comprise means for using the DCI format 14, to convert scheduling information 16 to the scheduling sequence 42 and, then, for using the look-up table 45, in reverse, to convert the scheduling sequence 42 into the index 40 indexing the scheduling sequence and, then, including the index 40 in the transmitted DCI sequence 12.

In the example illustrated, the network node, for example access node 120, comprises means 50 for controlling a population of the look-up table 45. The look-up table 45 is, for example, used for converting, at the UE 110, a received index 40 indexing a scheduling sequence 42 to the indexed scheduling sequence 42. The controller 50 can for example operate to minimize (or otherwise optimize) a size (e.g. number of entries) of the look-up table 45.

In at least some examples, the control is dependent upon a statistical model of scheduling sequences 42 previously signalled to the UE 110. In at least some examples, the statistical model is a machine learning model such as supervised learning for classification.

The machine learning can, for example, be used to learn geographical characteristics of a network cell. In this example, the machine learning can be based on scheduling sequences 42 previously signalled to all UEs 110 in that network cell or it can be based on scheduling sequences 42 previously signalled per UE 110 in that network cell. In particular, modulation and coding schemes (MCS) within the scheduling information 16 associated with entries in the look-up table 45 can be optimally defined. For example, different combinations of beam direction and MCS range encode different volumes of the cell, some of which will be occupied more frequently by a UE 110 or by all UEs 110 because of, for example, geographical relief (elevation) within the cell.

The network node 120 can be configured to initially send to the UE 110, via signalling at layer 3: the DCI format 12 and information 44 defining the look-up table 45.

The network node 120 can be configured to subsequently update the DCI format 12 and/or information 44 defining the look-up table 45 via signalling to the UE at layer 2.

The network node 120 can be configured to periodically send, to the UE 110, a DCI sequence 12 at the physical layer (layer 1). The DCI sequence 12 can be varied in each period.

In the preceding examples, the look-up table 45 predetermines the plurality of predetermined different scheduling sequences 42. In some but not necessarily all examples, the look-up table 45 comprises a plurality of entries associated with a DCI format 14, and maps, one-to-one, an index 40 to an entry that is a unique scheduling sequence 42. Each unique scheduling sequence 42 comprises a unique representation 18 of unique scheduling information 16. The representations 18 are in accordance with the associated DCI format 14. In at least some examples, the look-up table 45 is specific to the associated DCI format 14 and only comprises entries associated with the DCI format 14. The look-up table 45 can be replaced or updated when the DCI format 14 changes. Thus a reception of a new DCI format 14 can be accompanied by reception of information 44 defining the look-up table 45.

In at least some examples, the look-up table 45 is initially configured by layer 3 signalling. For example, information 44 defining the look-up table 45 is comprised in one or more RRC messages.

In at least some examples, the look-up table 45 is updated by layer 2 signalling. For example, information 44 defining the look-up table 45 is comprised in one or more MAC messages.

In at least some examples, the DCI format is sent using layer 3 signalling. For example, the DCI format 14 is comprised in one or more RRC messages.

The DCI sequence 12 is sent at layer 1 (physical layer). The DCI index 12 is a bit sequence comprising an index 40 indexing one of a plurality of predetermined different scheduling sequences 42. A DCI sequence 12 can be sent periodically. The DCI sequence 12 can be sent as a PDCCH payload. The DCI sequence 12 can be obtained at the UE 110 using blind decoding of PDCCH.

The index 40 is dense. The DCI sequence 12 and the index 40 can for example be as short as possible. They can for example comprise the minimum number of bits N in the index 40 needed to index M entries in the look-up table 45 where log₂M≤N<log₂M+1.

Considering a maximum size (number of entries) Mₘₐₓ in the lookup table 45, then the maximum number of bits Nₘₐₓ in the index 40 to index Mₘₐₓ entries in the look-up table 45 is log₂Mₘₐₓ≤Nₘₐₓ<log₂Mₘₐₓ+1.

In some examples the value of can be variable and be varied dynamically. In other examples, N can be fixed for example fixed as Nₘₐₓ.

The scheduling sequence 42 and the representation 18 comprised in the scheduling sequence 42 is a bit sequence, larger than the index 40. The index 40 therefore encodes the scheduling sequence 42/representation 18 via the look-up table 45 which acts as a codebook.

The DCI sequence 12 comprising the index 40 is a nominate DCI sequence 46 different to the legacy DCI index 24. For example, the nominate DCI sequence 24 can comprise an index 40 that is used, at the UE 110, to obtain 41 a representation 18 (scheduling sequence), based on a DCI format 24, of scheduling information 16 while the legacy DCI sequence 24 comprises the representation 18 (scheduling sequence), based on the legacy DCI format 24, of scheduling information 16.

In some examples, for example as illustrated in FIG. 3B, the representation 18, comprised in a scheduling sequence 42, is a representation based on a legacy DCI format 24.

Although FIGS. 2, 3A and 3B are illustrated separately, it should be appreciated that a user equipment 110 can be configured to operate in accordance with FIG. 3A and/or FIG. 3B. Such a user equipment can, optionally, also be configured to operate in accordance with FIG. 2.

A user equipment 110 can, for example, determine whether a received DCI sequence 12 is a legacy DCI sequence 22 or a nominate DCI sequence 46. If the received DCI sequence 12 is determined to be a nominate DCI sequence then the two-hop decoding method of FIG. 3A/3B is performed. If the received DCI sequence 12 is determined to be a legacy DCI sequence 22 then the one-hop legacy decoding method of FIG. 2 is performed. Thus the user equipment 110 previously described can also comprise means for: receiving a DCI sequence 12 (legacy DCI sequence 22) at the physical layer, the DCI sequence 12 (legacy DCI sequence 22) comprising a representation 18 (scheduling sequence), based on a legacy DCI format 24, of the scheduling information 16; and using a legacy DCI format 24, to obtain 13 the scheduling information 16, for configuring the mobile equipment 110 for data communication, from the representation 18, based on the legacy DCI format 24, of scheduling information 16.

The UE 110 can signal the access node 120 at the beginning of an RRC connection, for example, during the RACH process. The UE 110 can inform the network of its capabilities and other information. The capabilities and other information can be taken into account at the network. It can, for example, be used when configuring a look-up table 45 for the UE 110. It can, for example, be taken into account when determining whether to support the process of FIG. 3A, 3B or 2 at the network.

FIG. 6 illustrates an example of a controller 400. The controller 400 can be a controller for an apparatus. The apparatus can for example, be a terminal node, for example user equipment 110. Alternatively, the apparatus can be a network node, for example an access node 120.

Implementation of a controller 400 may be as controller circuitry. The controller 400 may be implemented in hardware alone, have certain aspects in software including firmware alone or can be a combination of hardware and software (including firmware).

As illustrated in FIG. 6 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus when loaded into the processor 402. The computer program instructions, of the computer program 406, provide the logic and routines that enables the apparatus to perform any of the methods illustrated in FIGS. 2, 3A, 3B, 4A, 4B, 5. The processor 402 by reading the memory 404 is able to load and execute the computer program 406.

The apparatus, for example user equipment 110, can therefore comprise:
at least one processor 402; and
at least one memory 404 including computer program code
the at least one memory 404 and the computer program code configured to, with the at least one processor 402, cause the apparatus 110 at least to perform:
use a look-up table, defined by received information, to convert an index to a scheduling sequence representing, based on a received DCI format, scheduling information, wherein the index is from a received DCI sequence; and
using the DCI format, to obtain the scheduling information, for configuring the mobile equipment for data communication, from the scheduling sequence representing, based on the DCI format, the scheduling information.

The apparatus, for example access node 120, can therefore comprise:
at least one processor 402; and
at least one memory 404 including computer program code
the at least one memory 404 and the computer program code configured to, with the at least one processor 402, cause the apparatus 120 at least to perform:
send to a user equipment (UE), via signalling at a higher layer than a physical layer:
a downlink control information (DCI) format, that enables the UE to obtain scheduling information, for scheduling the UE for data communication, from a scheduling sequence representing, based on the DCI format, the scheduling information; and information defining a look-up table for converting an index to a scheduling sequence representing, based on the DCI format, the scheduling information; and
send to the user equipment a DCI sequence at the physical layer, the DCI sequence comprising an index indexing one of a plurality of predetermined different scheduling sequences.

As illustrated in FIG. 7, the computer program 406 may arrive at the apparatus via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 406. The delivery mechanism may be a signal configured to reliably transfer the computer program 406. The apparatus may propagate or transmit the computer program 406 as a computer data signal.

A computer program 406 can comprise computer program instructions for causing an apparatus, for example user equipment 110, to perform at least the following or for performing at least the following:
use a look-up table, defined by received information, to convert an index to a scheduling sequence representing, based on a received DCI format, scheduling information, wherein the index is from a received DCI sequence; and
using the DCI format, to obtain the scheduling information, for configuring the mobile equipment for data communication, from the scheduling sequence representing, based on the DCI format, the scheduling information.

A computer program 406 can comprise computer program instructions for causing an apparatus, for example an access node 120, to perform at least the following or for performing at least the following:
send to a user equipment (UE), via signalling at a higher layer than a physical layer: a downlink control information (DCI) format, that enables the UE to obtain scheduling information, for scheduling the UE for data communication, from a scheduling sequence representing, based on the DCI format, the scheduling information; and
information defining a look-up table for converting an index to a scheduling sequence representing, based on the DCI format, the scheduling information; and
send to the user equipment a DCI sequence at the physical layer, the DCI sequence comprising an index indexing one of a plurality of predetermined different scheduling sequences.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2, 3A, 3B, 4A, 4B, 5 may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

FIG. 8 illustrates another example in which scheduling information 16 is transferred from a network node 120 to a terminal node, such as, for example, user equipment 110. The preceding description is also relevant for this example.

The scheduling information 16 is for scheduling the UE 110 for data communication,

As previously described, scheduling information 16 is encoded before transfer in accordance with a DCI format 14 to produce a scheduling sequence 18. The scheduling sequence 18 is a representation, based on the DCI format 14, of the scheduling information 16.

The scheduling sequence 18 is, for example, transferred to the UE 110 via an air interface between the network node 120 and the UE 110 using a DCI sequence 12. The DCI sequence 12 is physical layer signalling.

The manner in which the scheduling sequence 18 is transferred to the UE 110 can vary. The scheduling sequence 18 can, for example, be transferred explicitly as a payload of a DCI sequence 12. Alternatively, the scheduling sequence 18 can, for example, be transferred implicitly in a more deeply encoded form, for example as an index 40 (not illustrated) comprised in a DCI sequence 12, as previously described.

At the UE 110, the scheduling sequence 18 is decoded in accordance with DCI format 14 to produce the scheduling information 16.

The following description describes adjusting the DCI format 14, to reduce the number of possibilities covered by the scheduling sequence 18 and thereby enable a reduction of a size (bit width) of the scheduling sequence 18. The DCI format 14, is adjusted from a first DCI format 14₁ to a second, different DCI format 14₂.

As illustrated in FIG. 9, a DCI format 14 uses different fields 60 each of which has a different bit width 62. The bit width of a field 60 is the number of bits it can comprise. At least one of the fields 60 is an adjustable bit width field 60A having an adjustable bit width 62A. The adjustable bit width fields 60A can comprise an adjustable number of bits. In some examples, multiple fields 60 are adjustable bit width fields 60A having an adjustable bit width 62A. The multiple fields 60 can be independently adjustable bit width fields 60A having different and independently adjusted bit widths 62A. In some examples, one or more fields 60 are fixed bit width fields having a fixed bit width 62.

The DCI format 14 spans a multi-dimensional bit-width space, where each field 60 defines via its bit width 62 a dimension of the space. The space can accommodate an adjustable range of scheduling sequence permutations. The bit-width space spanned by the DCI format 14 and occupied by the range of scheduling sequence permutations is adjusted by adjusting a bit width 62A of an adjustable bit width field 60A of the DCI format 14.

In the example, illustrated in FIGS. 9A and 9B, the field 60 that is third from the left, is an adjustable bit width field 60A. The adjustable bit width field 60A has an adjustable bit width 62A. In FIG. 9A the first DCI format 14₁ defines a first bit width 62A₁ for the adjustable bit width field 60A. In FIG. 9B the second DCI format 14₂ defines a second bit width 62A₂ for the adjustable bit width field 60A.

The adjustment of the DCI format 14 is based on use or usability of scheduling sequences 18. The use or usability of scheduling sequences 18 determines what bit-width space spanned by an adaptive DCI format 14 is required.

An adjustable DCI format 14 encodes scheduling information 16 using different fields 60 of adjustable and/or fixed bit width 62 as a scheduling sequence 18.

In FIG. 8, the network node 120 sends to the user equipment 110 (UE) a first downlink control information (DCI) format 14₁ for encoding variable scheduling information 16 as a scheduling sequence 18. The scheduling sequence 18 is used to communicate scheduling information 16 to the UE 110, in accordance with the first DCI format 14₁, by assigning values to the fields 60 of the first DCI format 14₁ including the at least one field 62A of the first bit width 62A₁.

In dependence upon use or usability of scheduling sequences 18, the network node 120 sends to the UE 110 an adjusted second DCI format 14₂ for encoding variable scheduling information 16 as a scheduling sequence 18. The scheduling information 16 is for scheduling the UE 110 for data communication. The adjusted second DCI format 14₂ uses different fields 60 and the at least one adjustable bit width field 60A has a second bit width 62A₂ that is different to the first bit width 62A₁.

The dependency upon use or usability of scheduling sequences 18, can be a dependency upon use or usability of scheduling sequences 18 within an adjustable range of possible scheduling sequences 18 enabled by the adjustment of the bit width 62A of the at least one adjustable bit width field 60A of the DCI format 14 to the second bit width 62A₂.

The network node 120 then uses a scheduling sequence 18 to communicate scheduling information 16 to the UE 110, using the adjusted second DCI format 14₂, by assigning values to the fields 60 of the adjusted second DCI format 14₂ including the at least one adjustable bit width field 60A of the second bit width 62A₂.

The adjustment of the DCI format 14 is based on use or usability of scheduling sequences 18 of an adjustable range of possible scheduling sequences 18 enabled by the DCI format 14. In at least some examples, the at least one adjustable bit width field 60A has a selected one of a plurality of possible bit widths 62A. The range defines the number of permutations of scheduling sequences 18.

The adjustable bit width 62A may be constrained to a width of 2\hat{ }n bits where n is a whole number. The adjustable bit width 62A is adjusted by adjusting n.

FIGS. 10A to 10C, 11A & 11B and 12A & 12B illustrate adjustment of an adjustable bit width 62A of an adjustable bit width field 60A of the DCI format 14. The adjustment of the bit width 62 of the adjustable bit width field 60A is from a first bit width 62A₁ to a second bit width 62A₂.

The FIGs schematically illustrate a statistical model 70 of use and/or usability of scheduling sequences 18 as a one-dimensional probability distribution. In this example, the probability distribution can represent frequency of use (or usability) of scheduling sequences definable by the different permutations of the adjustable bit width field 60A.

In FIGS. 10A to 10C, the first bit width 62A₁ is sub-optimal for the statistical model 70. An improved bit width 62A can be obtained be re-sizing the bit width 62A. The bit width 62A can also optionally be repositioned.

In FIG. 10A, the first bit width 62A₁ is too wide for the statistical model 70. A more efficient overlap of the statistical model 70 and the bit width 62A can be achieved by narrowing the bit width 62A. The second bit width 62A₂ is smaller than the first bit width 62A₁.

In FIG. 10B, the first bit width 62A₁ is not optimally positioned for the statistical model A more efficient overlap of the statistical model 70 and the bit width 62A can be achieved by re-sizing and re-positioning the bit width 62A. The second bit width 62A₂ is re-sized and re-positioned compared to the first bit width 62A₁.

In FIG. 100, the first bit width 62A₁ is too narrow for the statistical model 70. A more efficient overlap of the statistical model 70 and the bit width 62A can be achieved by widening the bit width 62A. The second bit width 62A₂ is wider than the first bit width 62A₁.

Extremities 66 of the bit width 62A of the adjustable bit width field 60A define extremities of a range of possible scheduling sequences 18. The extremity of the range of possible scheduling sequences 18 has a likelihood of use (or usability). based on the value of the statistical model 70 corresponding to that extremity 66.

In FIG. 10A, both extremities 66 of the first bit width 62A₁ of the adjustable bit width field 60A define extremities of a range of possible scheduling sequences 18 that are under-used. After adjustment of the bit width 62A of the adjustable bit width field 60A, both extremities 66 of the second bit width 62A₂ of the adjustable bit width field 60A define extremities of a range of possible scheduling sequences 18 that are better used. In this example, both extremities 66 of the second bit width 62A₂ of the adjustable bit width field 60A define extremities of a range of possible scheduling sequences 18 that have a substantially equal likelihood of use.

In FIG. 10B, the rightmost extremity 66 of the first bit width 62A₁ of the adjustable bit width field 60A defines an extremity of a range of possible scheduling sequences 18 that is under-used. After adjustment of the bit width 62A of the adjustable bit width field 60A, that extremity 66 of the second bit width 62A₂ of the adjustable bit width field 60A defines an extremity of a range of possible scheduling sequences 18 that is better used. In this example, both extremities 66 of the second bit width 62A₂ of the adjustable bit width field 60A define extremities of a range of possible scheduling sequences 18 that have a substantially equal likelihood of use.

In FIG. 100, both extremities 66 of the first bit width 62A₁ of the adjustable bit width field 60A define extremities of a range of possible scheduling sequences 18 that are over-used. After adjustment of the bit width 62A of the adjustable bit width field 60A, both extremities 66 of the second bit width 62A₂ of the adjustable bit width field 60A define extremities of a range of possible scheduling sequences 18 that are better (more optimally) used. In this example, both extremities 66 of the second bit width 62A₂ of the adjustable bit width field 60A define extremities of a range of possible scheduling sequences 18 that have a substantially equal likelihood of use.

In FIGS. 10A & 10B, the adjustment for the first bit width 62A₁ of the adjustable bit width field 60A to the second bit width 62A₂ of the adjustable bit width field 60A decreases availability of low likelihood of use scheduling sequences 18.

In FIG. 10A, the adjustment for the first bit width 62A₁ of the adjustable bit width field 60A to the second bit width 62A₂ of the adjustable bit width field 60A decreases a range at the extremity of the range of possible DCI scheduling sequences 18, where the scheduling sequence 18 at that extremity is relatively under-used.

In FIG. 10B, the range of possible scheduling sequences 18 is offset because one extremity of the range of possible DCI scheduling sequences 18 defined by an extreme value 66 of the field 60A as defined by the DCI format 14 is over-used compared to an opposing extremity of the range of possible DCI scheduling sequences 18 defined by an opposing extreme value 66 of the field 60A as defined by the DCI format 14. The adjustment of the DCI format 14, causes an increase in the range at the extremity of the range of possible DCI scheduling sequences 18 that is over-used by extending (on the left) the field 60A beyond the extreme value, and a decrease in the range at the opposing extremity of the range of possible DCI scheduling sequences 18 by contracting the field 60A within the opposing extreme value.

In FIGS. 10A and 10B, the range of possible DCI scheduling sequences 18 is re-sized (reduced) because the range of possible DCI scheduling sequences 18, including both extremities of the range of possible DCI scheduling sequences 18 that are at extreme opposing values of a field 60A as defined by the DCI format 14, are under-used.

In FIG. 100, the range of possible DCI scheduling sequences 18 is re-sized (extended) because the range of possible DCI scheduling sequences 18, including both extremities of the range of possible DCI scheduling sequences 18 that are at extreme opposing values of a field 60A as defined by the DCI format 14, are over-used.

The adjustment of the first bit width 62A₁ of the adjustable bit width field 60A to the second bit width 62A₂ of the adjustable bit width field 60A increases a range at an extremity of the range of possible scheduling sequences 18, where the scheduling sequence 18 at that extremity is relatively over-used

In FIGS. 10B & 10C, the adjustment for the first bit width 62A₁ of the adjustable bit width field 60A to the second bit width 62A₂ of the adjustable bit width field 60A increases availability of high likelihood of use scheduling sequences 18.

FIGS. 11A & 11B illustrate an optimized adjustable bit width 62A of an adjustable bit width field 60A for a statistical model 70 at a first time (FIG. 11A) and an optimized adjustable bit width 62A of the adjustable bit width field 60A for the statistical model 70 at a second time later than the first time (FIG. 11B). The adjustment made from the first bit width 62A₁ of the at least one adjustable bit width field 60A to the second bit width 62A₁ of the at least one adjustable bit width field 60A increases a range of used or usable scheduling sequences 18.

FIGS. 12A & 12B illustrate an optimized adjustable bit width 62A of an adjustable bit width field 60A for a statistical model 70 at a first time (FIG. 12A) and an optimized adjustable bit width 62A of the adjustable bit width field 60A for the statistical model 70 at a second time later than the first time (FIG. 12B). The adjustment made from the first bit width 62A₁ of the at least one adjustable bit width field 60A to the second bit width 62A₁ of the at least one adjustable bit width field 60A decreases a range of used or usable scheduling sequences 18.

The same statistical model can be used in the examples of FIGS. 11A &11B and 12A & 12B.

It will therefore be appreciated that in these examples there is a dynamic adjustment of the DCI format 14 as the statistics of the statistical model 70 change over time. In these examples, the DCI format 14 ‘breathes’.

The adjustment of the adjustable bit width field 60A to the second bit width 62A₂ can be based on a statistical model 70 of use or usability of scheduling sequences 18. The adjustment of the adjustable bit width field 60A to the second bit width 62A₂ from the first bit width 62A₁ comparatively optimizes a function defined by the statistical model 70.

The first bit width 62A₁ defines a first range of possible scheduling sequences 18, the second bit width 62A₂ defines a second range of possible scheduling sequences 18 and the position and/or size of the second range is different to the first range. The difference in position and/or size optimizes an objective function.

As an example, in the embodiments illustrated in FIGS. 10A, 10B, 10C, the second bit width 62A₂ is optimized so that both extremities 66 of the second bit width 62A₂ of the adjustable bit width field 60A define extremities of a range of possible scheduling sequences 18 that have an expected probability P of being used.

In FIGS. 10A to 10C, the second bit width 62A₂ is adjusted, fora probability distribution 70, so that the target probabilities are hit at the extremities 66. The range of possible scheduling sequences 18 defined by the first bit width 62A₁ is sub-optimal for current use and the second bit width 62 defines a better range of possible scheduling sequences 18.

In FIGS. 11A & 11B and 12A & 12B, the second bit width 62A₂ is adjusted, for an changing probability distribution 70, so that the target probabilities are hit at the extremities 66.

The statistics of previously used or usable scheduling sequences 18 can be used to determine an adjustment of a bit width 62A.

In some but not necessarily all examples, the statistical model 70 is a model determined by unsupervised learning.

For example, the statistical model 70 is a model that clusters scheduling sequences 18 based on use and/or usability.

In the example illustrated in FIGS. 10A-10C, 11A to 11B, 12A to 12B the statistical model 70 is one-dimensional. However, in other examples the statistical model can be multi-dimensional. For example, a weighted combination of input vectors can be used to define an objective function that is optimized by a preferred bit width 62A of an adjustable field 60A (or set of preferred bit widths 62A of respective adjustable fields 60A). The weighted combination of input vectors can be learned using, for example, a neural network or K-means clustering.

The statistical model 70 can, for example, be a model that clusters scheduling sequences 18, in multiple dimensions, based on use or usability.

The multiple dimensions can enable differentiation between any one or more of: different UEs, different cell load requirements, different times, different speeds, different beam indexes, different pathloss, different traffic types, different channel quality metrics. These value can, for example, be used to define the input vectors.

Referring back to FIG. 8, the network node 12 comprises means for receiving from the UE 110 a report 80 indicative of measured usability of scheduling sequences 18 within an adjustable range of possible scheduling sequences 18.

In at least some examples, the usability of the scheduling sequences 18 in the range of possible DCI scheduling sequences 18 enabled by a DCI format 14 is based on a measured quality of communication using the scheduling sequences 18 of the range of possible scheduling sequences 18 enabled by the DCI format. The UE 110 measures a quality metric across the possible scheduling sequences 18 enabled by the current DCI format 14 and provides a report 80 to the network node 120.

The report 80 can therefore indicate a best or a group of best scheduling sequences 18. The reports 80 received at the network node 120 provide, over time, statistics that enable selecting a bit width 62A of an adjustable bit width field 60A in dependence upon the usability of scheduling sequences 18 within (the adjustable) range of possible scheduling sequences 18 currently enabled. For example, the cumulative frequency of received best scheduling sequences 18 can be converted to a probability distribution 70 as illustrated in FIGS. 10A-10C, 11A-1B, 12A-12B.

In some examples, the DCI format 14 can be initialized with a first bit width 62A₁ for the adjustable bit width field 60A that is a maximum size. The maximum possible sized DCI format 14 is configured in order to capture the initial statistics of all possible scheduling sequences 18. The statistical model 70 formed form the captured statistics can then be used to configure a DCI format 14 (probably with reduced size).

In some example, this may occur as a one-shot process.

In other examples, the process of collecting statistics of the scheduling sequences 18 enabled by a DCI format 14 is repeated with each new DCI format 14. The statistical model 70 formed form the captured statistics is updated and the updated statistical model can then be used to configure an update to the DCI format 14. Each update to the DCI format 14 can, for example, change a bit width 62A of an adjustable bit width field 60A. However, each update to a DCI format 14 does not have to change a bit width 62A of an adjustable bit width field 60A. Instead the bit width 62A can remain constant and a range of possible scheduling sequences 18 enabled by the bit width 62A can be changed by repositioning the bit width 62A.

In some other examples, a repeat pattern can be recognised in the repeated use of particular DCI Formats 14 (based on the statistical model 70 formed form the captured statistics) in particular repeating circumstances. That is a correlation is discovered between a particular set of circumstance (which can be defined by a set of contextual parameters) and a particular DCI Format 14 that, for example, has a particular adjustable bit width 62A of a particular adjustable bit width field 60A. A database can be created in a memory that stores the particular DCI Format 14 in association with the set of contextual parameters that define the particular circumstances in which that particular DCI Format has been found to be repeated. The network node 120 can then monitor the contextual parameters, some of which may be reported by UEs 110. When the monitored contextual parameters match a set of contextual parameters in the database, the particular DCI format associated with that matched set of contextual parameters in the database, can be re-used. Examples of contextual parameters could, for example, include an identification of a time of day and whether the day is a working day or a week-end or holiday. It would then be possible to repeatedly configure a DCI Format 14 that is suitable for ‘rush-hour’ by recognising when ‘rush-hour’ occurs based on the contextual parameters rather than on collecting and analysing statistics using the statistical model 70. This is possible because the statistical model can, in effect, be estimated/assumed based on the pattern of contextual parameters. This re-use of a DCI Format 14 can occur with any suitable repeating use pattern of DCI Formats. A repeating use pattern can be identified and recognised using machine learning. Thus in some examples, the procedure needs to be triggered according to UE geographical distribution update, for example around 6 pm in the afternoon, when office time ends and people transport back home. The learned formats can be stored in O&M functionality and applied regularly with people daily life time schedule. In at least some of these examples, UEs 110 can, for example, include mobile personal telephones, in-vehicle or road side devices that are part of an autonomous vehicle system.

As previously described, in at least some examples, the scheduling sequence 18 is communicated, to the UE 110, implicitly or explicitly, using physical layer signalling and the adjusted DCI format 14 is sent to the UE 110 via higher layer signalling e.g. a layer 2 or 3.

In some examples the scheduling sequence 18 is communicated, to the UE 110, implicitly by, at the UE 110:
receiving via signalling at a higher layer than the physical layer, information defining a look-up table for converting a received index to a scheduling sequence 18 representing, based on the DCI format 14, scheduling information 16;
   receiving a DCI sequence 12 at the physical layer, the DCI sequence comprising an index 40 for indexing one of a plurality of predetermined different scheduling sequences 18;
   using the look-up table to convert the received index 40 to a scheduling sequence 18 representing, based on the DCI format 14, scheduling information 16; and
   using the DCI format 14 to obtain the scheduling information 16, for configuring the mobile equipment for data communication from the scheduling sequence 18 representing, based on the DCI format 14, the scheduling information 16.

FIG. 13 illustrates a method 300. The method 300 can be performed at the network for example at a network node 120. The method 300 can be used to adjust a DCI format 14. The DCI format 14 can be adjusted by adjusting a bit width 62A of an adjustable bit width field 60A of the DCI format 14.

The method 300 comprises, at block 302, sending to a user equipment 110 (UE) a downlink control information (DCI) format 14 for encoding variable scheduling information 16 as a scheduling sequence 18. The scheduling information 16 is for scheduling the UE 110 for data communication. The DCI format 14₁ uses different fields 60 and at least one of the fields 60 is an adjustable bit width field 60A having a first bit width 62A₁.

The method 300 comprises, at block 304, using a scheduling sequence 18 to communicate scheduling information 16 to the UE 110, using the DCI format 14₁. Values are assigned to the fields 60 of the DCI format 14₁ including the at least one adjustable bit width field 60A that has the first bit width 62A₁.

The method 300, at block 306, adjusts the DCI format 14₁ to a new DCI format 14₂. The adjustment is dependent upon use or usability of scheduling sequences 18 within an adjustable range of possible scheduling sequences 18. The adjustable range of possible scheduling sequences is enabled by a variation in a bit width 62 of the at least one adjustable bit width field 60A of the DCI format 14. The adjusted DCI format 14₂ is such that the adjustable bit width field 60A has a second bit width 62A₂ that is different to the first bit width 62A₁.

The method 300 comprises, at block 308, sending to the UE 110 the adjusted DCI format 14₂ for encoding variable scheduling information 16 as a scheduling sequence 18. The scheduling information 16 is for scheduling the UE 110 for data communication. The adjusted DCI format 14₂ uses different fields 60 and the at least one adjustable bit width field 60A has a second bit width 62A₂ that is different to the first bit width 62A₁.

The method 300 comprises, at block 308, using a scheduling sequence 18 to communicate scheduling information 16 to the UE 110, using the adjusted DCI format 14₂, by assigning values to the fields 60 of the adjusted DCI format 14 including the at least one adjustable bit width field 60A of the second bit width 62A₂.

A controller 400, for example as previously described in relation to FIG. 6, can be used to perform the method 300 or control performance of the method 300. The controller 400 can be a controller for an apparatus such as network node, for example an access node 120.

The apparatus, for example network node 120, can therefore comprise:
at least one processor 402; and
at least one memory 404 including computer program code
the at least one memory 404 and the computer program code 406 configured to, with the at least one processor 402, cause the apparatus 110 at least to perform:
changing, in dependence upon use or usability of scheduling sequences 18 within an adjustable range of possible scheduling sequences 18 enabled by a variation in a bit width 62 of the at least one adjustable bit width field of the DCI format, a downlink control information (DCI) format 14 for encoding variable scheduling information 16 as a scheduling sequence 18, wherein the scheduling information 16 is for scheduling the UE 110 for data communication, and wherein the DCI format 14 uses different fields 60 and at least one of the fields 60 is an adjustable bit width field having a first bit width 62. The downlink control information (DCI) format 14 can be changed by adjusting a bit width 62 of a field 60.

A computer program 406, for example as illustrated in FIG. 7, can comprise computer program instructions for causing an apparatus, for example a network node 120, to perform at least the following or for performing at least the following:
changing, in dependence upon use or usability of scheduling sequences 18 within an adjustable range of possible scheduling sequences 18 enabled by a variation in a bit width 62 of the at least one adjustable bit width field of the DCI format, a downlink control information (DCI) format 14 for encoding variable scheduling information 16 as a scheduling sequence 18, wherein the scheduling information 16 is for scheduling the UE 110 for data communication, and wherein the DCI format 14 uses different fields 60 and at least one of the fields 60 is an adjustable bit width field having a first bit width 62. The downlink control information (DCI) format 14 can be changed by adjusting a bit width 62 of a field 60.

The user equipment 110 can be configured to enable the methods described with reference to FIGS. 8 to 13.

In at least some examples, the user equipment 110 is configured to allocate memory in response to receiving the DCI format 14₁ comprising the adjustable bit width field having the first bit width 62A₁. The memory allocation means allocates first memory resources of a size determined by the first bit width 62A₁. The user equipment 110 is configured to allocate memory in response to receiving the DCI format 14₂ comprising the same adjustable bit width field 60A having the second bit width 62A₂. The memory allocation means allocates second memory resources of a size determined by the second bit width 62A₁.

In at least some examples, the user equipment 110 is configured to adjust what measurements are performed to create reports 80 sent to the network node 120. The UE 110, in response to receiving the DCI format 14₁ comprising the adjustable bit width field 60A having the first bit width 62A₁, measures usability of scheduling sequences 18 in a range of scheduling sequences 18 dependent upon the first bit width 62A₁ and reports 80 to the network node 120 an indication of measured usability of scheduling sequences 18 in the range of DCI scheduling sequences 18 dependent upon the first bit width 62A₁. The UE 110, in response to receiving the DCI format 14₂ comprising the adjustable bit width field 60A having the second bit width 62A₂, measures usability of scheduling sequences 18 in a range of scheduling sequences 18 dependent upon the second bit width 62A₂ and reports 80 to the network node 120 an indication of measured usability of scheduling sequences 18 in the range of scheduling sequences 18 dependent upon the second bit width 62A₂.

An illustrative use case, for controlling adjustment of the bit width 62A of an adjustable bit width field 60A of a DCI format 14 is described in the following paragraphs, where the DCI format 14 is a 3GPP DCI format and the adjustable bit width field 60A is a Modulation and Coding Scheme (MCS) field.

In 3GPP Rel-16, DCI formats X_2, some fields can have a configurable bit width. Some of the fields can be configured to be zero bit width, which means the feature is totally disabled. The fields in the DCI format are separately configured and once configured the format is fixed unless RRC reconfiguration is triggered which is quite expensive.

With a smaller size DCI format 14, we can for the same PDCCH resources pack more users' DCI or we can use lower code rate so the DCI can reach further, however feature flexibility is constrained as we have less bits to configure the feature options (the different scheduling sequences 18).

The total number of bits for DCI format 2_1 could be at maximum 76 bits (assuming the FDRA (Frequency domain resource assignment) field is 8 bits). When the maximum number of bits is configured, it implies that all related functionality/features are enabled with the most flexibility of scheduling (with all the feature options).

It would be desirable to adjust the DCI format 14, to make it of smaller size, while maintaining feature flexibility. A trade-off needs to be found between feature flexibility and size reduction, so that the DCI format 14 is configured with only with those features/options that are necessary and efficient.

Let us assume a modification to DCI format 2_1 to allow the Modulation and Coding Scheme (MCS) field 60 of the DCI format 14 which has a bit width 62 that is currently fixed at 5 bits to become an adjustable bit width field 62A with an adjustable bit width 62A.

The following methods can abstract the geographical and channel environment of UEs 110 and use the information to configure DCI formats 14 based on machine learning methods.

A geographical distribution of UEs 110 in the cell coverage space and the associated channel environment (network layout, deployment . . . ) determine the necessary features (the fields 60A in the DCI format 14) and their best bit widths 62A (the bit width 62A of a field 62A determines the range of available feature options i.e. the range of possible scheduling sequences 18).

In FIG. 14, the coverage space of a cell is divided into MCS ranges. Each MCS index corresponds to a different UE distance and different pathloss. Each beam index corresponds to a different UE orientation with respect to the boresight. The different combinations of MCS index and beam index divide the space into blocks A, B, C, D, F, G, H, I. For blocks A, B, C, E, F, and H, there will rarely be any UE presence because usually a UE doesn't float in the air and make a phone call! Therefore, when the DCI formats 14 in this cell are configured, we should aim to omit the corresponding MCS and beam index pairs that are not used or usable.

The following methods learn this geographical characteristic automatically and use it to configure the MCS field.

Machine learning can be used to learn the geographical characteristic of the UE distribution and network deployment. The learned information can be used to select only the necessary features (ranges of scheduling sequences 18) and accordingly configure the bit widths 62A of the adjustable bit width fields 60 of the DCI format 14.

The method can be divided into:
1) a preparation stage
2) a learning stage
3) a decision stage.

At the preparation stage, the DCI format 14 is configured to a maximum size with adjustable bit width fields 60A having maximum bit widths 62A. Statistics for possible ranges of scheduling sequences 18 (e.g. statistics for MCS indexes) are collected.

At the learning stage, the statistics are used to teach a statistical model 70. The statistical model 70 learns, automatically and unsupervised, a grouping of used or usable scheduling sequences 18.

At the decision stage, the grouping of used/usable scheduling sequences 18, is used to determine: a target scheduling sequence range; the mapping of the scheduling sequence range to the full range of scheduling sequences 18; and the size of the bit width 62A of adjustable bit width field(s) 60A required to implement the target scheduling sequence range.

In the following a simple scenario with two users in a cell is used as an example to illustrate adjustment of a bit width 62A of the MCS field 60A.

At the preparation stage, the MCS field is configured to a maximum size with 5 bits. The MCS indexes scheduled by the network for the UEs are recorded. Alternatively or additionally, the best MCS indexes reported 80 by the UEs can be recorded. Thus used and/or usable MCS indexes can be recorded.

The collected MCS indexes are fed into the machine learning algorithm as an input 25 vector to learn the MCS statistical distribution. The machine learning method can, for example, use unsupervised learning with a mixture of Gaussian model (here Gaussian distribution is assumed for the UE channel, we can assume other distribution alternatively, such as Rayleigh distribution), to learn the cluster/distribution of MCS indexes for the two users.

FIG. 15 illustrates an example of learned probability distributions (probability density functions) for the MCS indexes of the two users. There is a cluster of most probably used/usable MCS indexes for a first UE and a cluster of most probably used/usable MCS indexes for the second UE. Each cluster has an associated probability density function. The probability density function for the first UE has a mean at MCS index 5. The probability density function for the second UE has a mean at MCS index 23. The MCS index can vary between 0 and 31.

The machine learning algorithm can, for example, provide the mean and variance of the probability density function associated with the first user and the mean and variance of the probability density function associated with the second user. This statistical model 70 can be used to configure the MCS field 60A.

As an example, only the MCS indexes within a threshold distance of the mean (e.g. 3 dB) are configured, which could be MCS index 2 to 8 for the first UE (3 bits can cover indexes 1 to 8 or 2 to 9 and be ‘centered’ on the mean at MCS index 5) and MCS index 20 to 26 for the second UE (3 bits can cover indexes 19 to 26 or 20 to 27 and be ‘centered’ on the mean at MCS index 23).

Other MCS indexes are hardly used in the network and can be neglected.

Compared with blind configuration with maximum size of 5 bits, 2 bits are saved for the MCS field 60A for both of the two users without performance loss.

The approach can be extended to multiple fields and with more than two users. A mixture of multiple dimension Gaussian model can be used. Each of the dimensions can correspond to an adjustable bit width field 60A, and a vector in the multiple dimension Gaussian distribution corresponds to a scheduling sequence 18 with all fields. Applying the same procedure, we can learn the grouping/distribution of the scheduling sequences 18 for the users and then use the statistics to select the necessary range of scheduling sequences 18 and accordingly configure the adjustable bit with fields 60A for the DCI format 14.

In principle, the procedure can be triggered at the beginning once the network deployment is done and from time to time when the UE geographical distribution changes. For a fixed wireless access network, one shot execution of the proposed procedure may be good enough and the benefit could sustain the whole network lifecycle.

Where a structural feature has been described, it may be replaced by means for performing one or more of the functions of the structural feature whether that function or those functions are explicitly or implicitly described.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

The above described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one.” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A network node comprising:
at least one processor; and
at least one memory including computer program code;
the at least one memory and the computer program code configured to, with the at least one processor, cause the network node at least to perform;
sending to a user equipment (UE) a downlink control information (DCI) format for encoding variable scheduling information as a scheduling sequence, wherein the scheduling information is for scheduling the UE for data communication, and wherein the DCI format uses different fields and at least one of the fields is an adjustable bit width field having a first bit width;
using a scheduling sequence to communicate scheduling information to the UE, using the DCI format, by assigning values to the fields of the DCI format including the at least one field of the first bit width;
in dependence upon use or usability of scheduling sequences within an adjustable range of possible scheduling sequences enabled by a variation in a bit width of the at least one adjustable bit width field of the DCI format, sending to the UE an adjusted DCI format for encoding variable scheduling information as a scheduling sequence, wherein the scheduling information is for scheduling the UE for data communication, and wherein the adjusted DCI format uses different fields and the at least one adjustable bit width field has a second bit width that is different to the first bit width and wherein an adjustment of the adjustable bit width field to the second bit width is based on a statistical model of use or usability of scheduling sequences wherein the adjustment of the adjustable bit width field to the second bit width from the first bit width comparatively optimizes a function defined by the statistical model and wherein the statistical model is a model determined by unsupervised learning; and
using a scheduling sequence to communicate scheduling information to the UE, using the adjusted DCI format, by assigning values to the fields of the adjusted DCI format including the at least one adjustable bit width field of the second bit width.

2. A network node as claimed in claim 1, wherein adjustment of the DCI format is based on use or usability of scheduling sequences within an adjustable range of possible scheduling sequences enabled by a variation in a bit width of the at least one adjustable bit width field of the DCI format, wherein the DCI format uses different fields and wherein the at least one adjustable bit width field has a selected one of a plurality of possible bit widths.

3. A network node as claimed in claim 1, wherein the second bit width is less than the first bit width.

4. A network node as claimed in claim 1 wherein an adjustment of the first bit width of the at least one adjustable bit width field to the second bit width of the at least one adjustable bit width field decreases under-used scheduling sequences.

5. A network node as claimed in claim 1 wherein an adjustment for the first bit width of the at least one adjustable bit width field to the second bit width of the at least one adjustable bit width field increases a range of used or usable scheduling sequences.

6-7. (canceled)

8. A network node as claimed in claim 1, wherein the statistical model is a model that clusters scheduling sequences based on use or measured usability.

9. A network node as claimed in claim 8, wherein the statistical model is a model that clusters scheduling sequences, in multiple dimensions, based on use or measured usability.

10. A network node as claimed in claim 1, wherein the at least one memory and the computer program code, with the at least one processor, are further configured to cause the network node at least to perform for receiving from the UE a report indicative of measured usability of scheduling sequences within an adjustable range of possible scheduling sequences defined by the DCI format.

11. A network node as claimed in claim 1, wherein a scheduling sequence is communicated, to the UE, implicitly or explicitly, using physical layer signalling and wherein the adjusted DCI format is sent to the UE via higher layer signalling.

12. A method comprising:
sending to a user equipment (UE) a downlink control information (DCI) format for encoding variable scheduling information as a scheduling sequence, wherein the scheduling information is for scheduling the UE for data communication, and wherein the DCI format uses different fields and at least one of the fields is an adjustable bit width field having a first bit width;
using a scheduling sequence to communicate scheduling information to the UE, using the DCI format, by assigning values to the fields of the DCI format including the at least one field of the first bit width;
in dependence upon use or usability of scheduling sequences within an adjustable range of possible scheduling sequences enabled by a variation in a bit width of the at least one adjustable bit width field of the DCI format, sending to the UE an adjusted DCI format for encoding variable scheduling information as a scheduling sequence, wherein the scheduling information is for scheduling the UE for data communication, and wherein the adjusted DCI format uses different fields and the at least one adjustable bit width field has a second bit width that is different to the first bit width and wherein an adjustment of the adjustable bit width field to the second bit width is based on a statistical model of use or usability of scheduling sequences wherein the adjustment of the adjustable bit width field to the second bit width from the first bit width comparatively optimizes a function defined by the statistical model and wherein the statistical model is a model determined by unsupervised learning; and
using a scheduling sequence to communicate scheduling information to the UE, using the adjusted DCI format, by assigning values to the fields of the adjusted DCI format including the at least one adjustable bit width field of the second bit width.

13. A non-transitory computer readable medium that when loaded by at least one processor enables:
changing in dependence upon use or usability of scheduling sequences within an adjustable range of possible scheduling sequences enabled by a variation in a bit width of the at least one adjustable bit width field of the DCI format, a downlink control information (DCI) format for encoding variable scheduling information as a scheduling sequence, wherein the scheduling information is for scheduling the UE for data communication, and wherein the DCI format uses different fields and at least one of the fields is an adjustable bit width field having a first bit width.

14. A system comprising a network node as claimed in claim 1 and at least the user equipment, wherein the user equipment comprises
at least one processor; and
at least one memory including computer program code;
the at least one memory and the computer program code configured to, with the at least one processor, cause the user equipment at least to perform;
in response to receiving the DCI format comprising the adjustable bit width field having the first bit width, allocating first memory resources of a size determined by the first bit width, and
in response to receiving the DCI format comprising the adjustable bit width field having the first bit width, releasing the first memory resources and allocating second memory resources of a size determined by the second bit width.

15. A system comprising a network node as claimed in claim 1 and at least the user equipment, wherein the user equipment comprises
at least one processor; and
at least one memory including computer program code;
the at least one memory and the computer program code configured to, with the at least one processor, cause the user equipment at least to perform;
in response to receiving the DCI format comprising the adjustable bit width field having the first bit width, measuring usability of scheduling sequences in a range of DCI scheduling sequences dependent upon the first bit width and reporting to the network node an indication of measured usability of scheduling sequences in the range of DCI scheduling sequences dependent upon the first bit width; and in response to receiving the DCI format comprising the adjustable bit width field having the second bit width, measuring usability of scheduling sequences in a range of DCI scheduling sequences dependent upon the second bit width and reporting to the network node an indication of measured usability of scheduling sequences in the range of DCI scheduling sequences dependent upon the second bit width.
